(19) United States
(12) Patent Application Publication
(10) Pub. No.: US 2023/0275434 A1
(43) Pub. Date: Aug. 31, 2023

(54) Controlling Reactive Power of a Power Grid

(71) Applicant: Telefonaktiebolaget LM Ericsson (publ), Stockholm (SE)

(72) Inventors: Lackis Eleftheriadis, Valbo (SE); Xiaoyu Lan, Täby (SE); Farnaz Moradi, Stockholm (SE); Ajmal Muhammad, Sollentuna (SE)

(21) Appl. No.: 18/015,757

(22) PCT Filed: Jul. 14, 2020
(86) PCT No.: PCT/SE2020/050732

§ 371 Date: Jan. 12, 2023

(51) Int. Cl. H02J 3/14; H02J 3/16; H04W 36/22

(52) U.S. Cl. CPC H02J 3/14; H02J 3/16; H04W 36/22; H02J 2310/16; H02J 2310/60

(57) ABSTRACT

The present disclosure relates to methods and devices (101, 106) of controlling reactive power of a power grid. In an aspect, a method of a radio base station (101) of controlling reactive power of a power grid is provided. The method comprises measuring (S101) an electrical property indicating a level of the reactive power supplied by the power grid to which the radio base station (101) is connected, and performing (S102) an action to stabilize the level of the reactive power of the power grid upon the measured electrical property reaching a certain value.

### TECHNICAL FIELD

The present disclosure relates to methods and devices of controlling reactive power of a power grid.

### BACKGROUND

In future smart grid applications, where more integrated alternative energy sources are needed, the power grid will be more volatile and more dynamic. In such an environment, stability of the power grid is of even greater importance than today's grids.

One critical factor is maintaining sufficiently high voltage levels and/or mitigating voltage variation of the alternating current (AC) power grid.

This is easier in a scenario where a new power grid is provided, such as when building a new housing district, where grid design and capabilities are handled from scratch, but is more difficult in an already available power grid and in available power grid that requires expansion.

To be able to deliver power via the power grid, the grid must be capable of producing both active power and reactive power. The reactive power maintains the voltage level of power transmission lines so that the active power can be transported over the transmission lines in order to power any equipment connected to the grid. Hence, the capacity of the grid to produce both active and reactive power is of great importance.

Reactive power units are currently distributed in the power grid to provide reactive power at selected locations of the grid, which requires heavy investments of the power grid operators. These reactive power units further need to be controlled more or less instantly, which is not always possible due to latency (>1 second).

### SUMMARY

An objective is to solve, or at least mitigate, this problem in the art and thus to provide an improved method of controlling reactive power of a power grid.

This objective is attained in a first aspect by a method of a radio base station of controlling reactive power of a power grid. The method comprises measuring an electrical property indicating a level of the reactive power supplied by the power grid to which the radio base station is connected, and performing an action to stabilize the level of the reactive power of the power grid upon the measured electrical property reaching a certain value.

This objective is attained in a second aspect by a radio base station configured to control reactive power of a power grid, the radio base station comprising a processing unit and a memory, said memory containing instructions executable by said processing unit, whereby the radio base station is operative to measure an electrical property indicating a level of the reactive power supplied by the power grid to which the radio base station is connected, and perform an action to stabilize the level of the reactive power.

This objective is attained in a third aspect by a method of a device communicating with a group of radio base stations for controlling reactive power of a power grid. The method comprises receiving, from at least one of the radio base stations, an indication of a level of the reactive power of the power grid to which said at least one radio base station is connected, and performing an action to stabilize the level of the reactive power of the power grid upon the received indication indicating that the level of the reactive power of the power grid has reached a certain value.

This objective is attained in a fourth aspect by a device configured to communicate with a group of radio base stations for controlling reactive power of a power grid, the device comprising a processing unit and a memory, said memory containing instructions executable by said processing unit, whereby the device is operative to receive, from at least one of the radio base stations, an indication of a level of the reactive power of the power grid to which said at least one radio base station is connected, and perform an action to stabilize the level of the reactive power of the power grid upon the received indication indicating that the level of the reactive power of the power grid has reached a certain value.

Advantageously, by having a radio base station, such as an Integrated Access and Backhaul (JAB) node, locally determine that the reactive power of the power grid to which the IAB-node is connected requires stabilizing and perform an appropriate action in response thereto, such as for instance supplying reactive power to the grid, the stabilizing of the grid is rapidly performed. Alternatively, the IAB-node may report to a device such as an IAB-donor that stabilizing is required, which IAB-donor instructs the IAB-node to take action accordingly.

In embodiments, the action performed to stabilize variation of the reactive power of the power grid includes generating a reactive power at the radio base station and supply the generated reactive power to the power grid, handing over one or more wireless communication devices served by the radio base station to one or more neighbouring base stations to decrease the load of the radio base station on the power grid, and inactivating power-consuming components of the radio base station to decrease the load of the radio base station on the power grid. Alternatively, the actions performed are determined and communicated to the radio base station by a supervising device such as an IAB-donor.

In a further embodiment, the supervising device may route data to the group of radio base stations such that no data is routed via a radio base station indicating that the level of the reactive power of the power grid has reached a certain value.

In a further embodiment, the supervising device instructs a radio base station indicating that the level of the reactive power of the power grid has reached a certain value to inactivate a radio cell it is serving.

In an embodiment, a path via which the routing of data will occur is defined in a Backhaul Adaptation Protocol (BAP) header.

In an embodiment, the indication of a level of the reactive power of the power grid to which said at least one radio base station is connected is included in a predetermined controlled symbol transported in the BAP header.

In an embodiment, the electrical property is one selected from a group comprising voltage, current or reactive power supplied by the power grid to which the radio base station is connected.

In an embodiment, said action is performed when a measured value of the electrical property falls below a predetermined voltage threshold value, or when measured values of the electrical property over time varies more than a threshold value from a nominal value.

In an embodiment, said certain value and/or the action to be performed is determined using Machine Learning (ML).

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 shows a so-called Integrated Access and Backhaul (JAB) network in which embodiments may be implemented;

FIG. 2 illustrates a flowchart of a method performed by an IAB-node of controlling reactive power of a power grid in an embodiment;

FIG. 3 illustrates a flowchart of a method performed by an JAB-node of controlling reactive power of a power grid in another embodiment;

FIG. 4 illustrates a flowchart of a method performed by an IAB-donor of controlling reactive power of a power grid in an embodiment;

FIG. 5 illustrates a flowchart of a method performed by an JAB-donor of controlling reactive power of a power grid in another embodiment;

FIG. 6 illustrates a flowchart of a method performed by an IAB-donor of controlling reactive power of a power grid in yet an embodiment;

FIG. 7 illustrates a Backhaul Adaptation Protocol (BAP) header;

FIG. 8 illustrates a radio base station according to an embodiment; and

FIG. 9 illustrates a supervising device according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

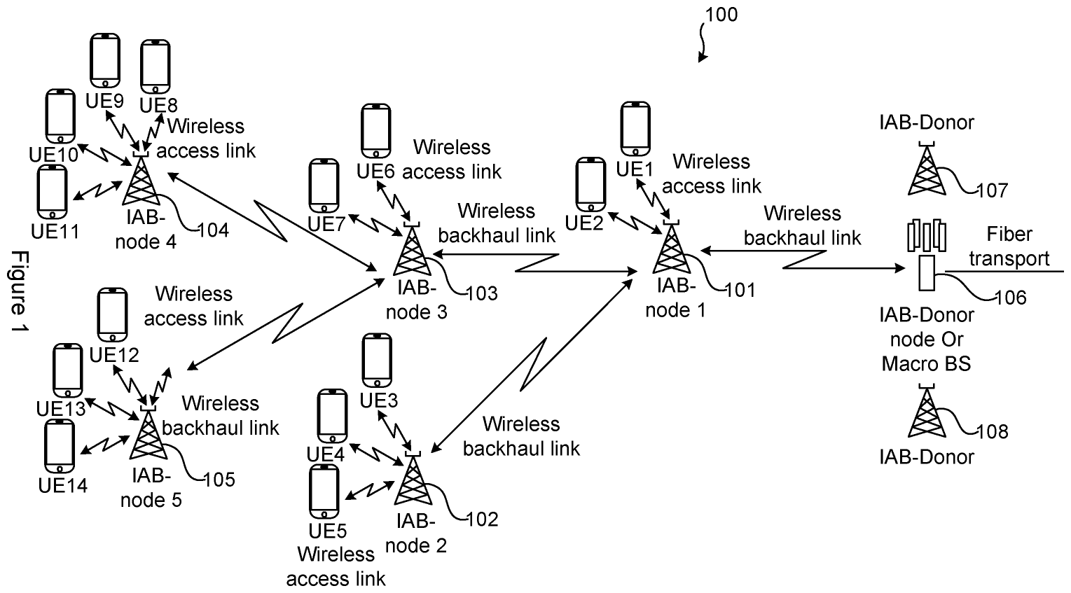

FIG. 1 illustrates a wireless communications network 100 utilized to control reactive power of a power grid such that a level of the reactive power is maintained at a required level in the power grid and/or such that excessive variations in the reactive power are avoided or at least mitigated according to an embodiment.

FIG. 1 shows a so called Integrated Access and Backhaul (JAB) network 100 where a number of radio base stations (RBSs) 101-105 referred to as JAB-nodes connects via wireless backhaul links to a macro RBS 106 referred as JAB-donor, while providing radio access networks (RANs) via wireless access links to a plurality of wireless communication terminals, commonly referred to as user equipment (UE), UE1-U14. The IAB-donor 106 is in turn connected to a core network (not shown) via a fibre transport link, and may further be connected to other JAB networks via further IAB-donors 107, 108. In an JAB network 100, only a fraction of the RBSs— i.e. the IAB-donors 106, 107, 108— connect to traditional fibre-like infrastructures, while the others—i.e. the IAB-nodes 101-105— wirelessly relay the back-haul traffic, possibly through multiple hops.

It should be noted that even though embodiments are described with reference to an IAB network, it may be envisaged that in for instance a Long Term Evolution (LTE) network, eNodeBs could for instance perform the tasks of the JAB-nodes while e.g. a Mobility Management Entity (MME) performs the task of the JAB-donor.

Currently, RANs are designed with macro base stations located approximately every 1-3 km and even closer in dense environments. Furthermore, in fifth generation (5G) New Radio (NR), IAB is utilized to provide greater bandwidth by dense deployment of NR cells without the need for densifying the wired transport network to the same extent. Due to the short range of mm-wave access, extension of wireless backhauling to multiple hops is an essential feature of JAB networks.

Now, in the network 100 each RBS/IAB-node 101-105 is connected to the power grid such that the JAB-node and its components, e.g. antenna arrays, power supply units (PSUs), radio transceivers, etc., are supplied with power.

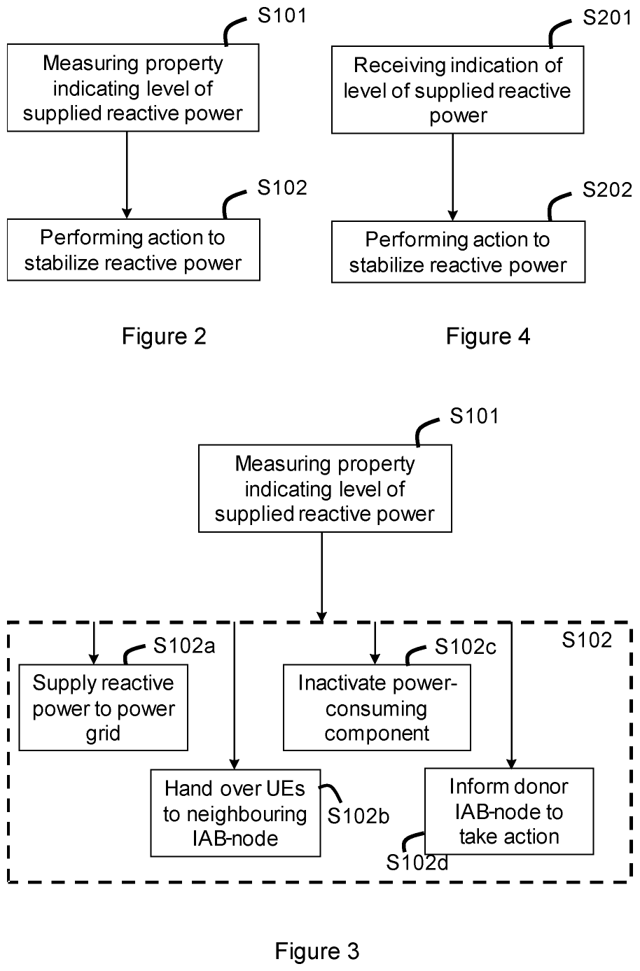

FIG. 2 illustrates a flowchart of a method performed by an JAB-node such as first JAB-node 101 of locally controlling reactive power of a power grid to which the JAB-node is connected, in an embodiment.

In a first step S101, the first JAB-node 101 measures an electrical property that gives an indication of a level of the reactive power supplied by the power grid to which the first IAB-node 101 is connected.

For instance, one or more PSUs of the first IAB-node 101 may measure an electrical property in the form of the voltage, current or reactive power supplied by the power grid to which the first IAB-node 101 is connected.

In the following, the measured electrical property is exemplified as being the voltage V supplied by the power grid.

If the measured voltage V for instance falls below a predetermined voltage threshold value V_{T}, i.e. V<V_{T}, or if the measured voltage excessively varies over time, e.g. if the measured voltage V varies more than 5% from a nominal voltage V_{N} over a time period T, the first IAB-node 101 concludes that an appropriate measure should be taken, and accordingly performs an action to stabilize the level of the reactive power of the power grid in step S102.

With reference to FIG. 3, in a first embodiment, the action taken by the first IAB-node 101 is to instantly generate a reactive power and supply the generated reactive power in step S102a to the power grid. The first IAB-node 101 may be equipped with a reactive power generator such as e.g. a capacitor bank or a photovoltaic (PV) inverter activated by the first IAB-node 101 if the measurement indicates that the reactive power needs to be stabilized, for instance by the measured voltage V falling under the threshold value V_{T}.

With reference again to FIG. 3, in a second embodiment, the action taken by the first JAB-node 101 is to off-load UE radio traffic to a neighbouring IAB-node. For instance, the first JAB-node 101 may in step S102b hand over UE1 to second JAB-node 102 or to third JAB-node 103, having as a result that less power is consumed by the first JAB-node 101 and the reactive power of the grid at the first IAB-node 101 will be stabilized at a higher level.

With reference to FIG. 3, in a third embodiment, the action taken by the first JAB-node 101 is in step S102c to temporarily inactivate power-consuming components of the first IAB-node 101 to decrease the load on the power grid.

For instance, for an antenna array, one or more antenna elements may be temporarily turned off. As an example, 5G communications systems is expected to support 64 transmitter and 64 receiver (64T64R) multiple-input and multiple-output (MIMO) arrays which will require more power amplifiers, analogue-to-digital converters, processing units, etc. Again, this will stabilize the reactive power of the grid at the first JAB-node 101 at a higher level.

With reference again to FIG. 3, in a fourth embodiment, the action taken by the first JAB-node 101 is to send an indication to a supervising device, in this case the JAB-donor 106, in step S102d that the measurement performed by the first JAB-node 101 indicates that the reactive power of the grid locally at the first JAB-node 101 needs to be stabilized, and that the JAB-donor 106 needs to perform an appropriate action accordingly. This will be discussed in more detail in the following. Different actions can be taken, based on the degree of reactive power stabilization needed.

Advantageously, with the embodiments of FIGS. 1-3, one or more of the IAB-nodes 101-106 determinates locally whether or not the power grid requires stabilizing and performs an action accordingly as described above.

Further advantageous is that the latency is very low, in particular when the IAB-nodes 101-105 locally performs the action of instantly stabilizing the reactive power of the power grid.

Another advantage is that that the JAB-nodes 101-105 are closely arranged in the JAB network 100, such as every 500 m, acting as power grid checkpoints.

As is understood, the method performed by the first IAB-node 101 may further be performed by one or more of the other IAB-nodes 102-105 in the network 100. Further a combination of two or more of steps S102a-S102d may be envisaged. It is further understood that further IAB-nodes may be connected to the IAB-donor 106 via the other two IAB-donors 107, 108.

FIG. 4 illustrates a further embodiment, where the IAB-donor 106 takes a decision on what action(s) to be taken to stabilize the reactive power after having received measurement reports from one or more of the IAB-nodes 101-105.

Thus, in a first step S201, the IAB-donor 106 receives, from one or more of the IAB-nodes 101-105, an indication of a level of the reactive power of the power grid to which said at least one radio base station is connected. This reporting of the IAB-nodes 101-105 may be triggered by the IAB-donor 106 using F1 or Radio Resource Control (RRC) signalling to request the indications.

In line with previous discussions, this indication may be in the form of a measured electrical property such as voltage, current, reactive power, etc. falling below a threshold value, or that the measured property indicates instability in the grid.

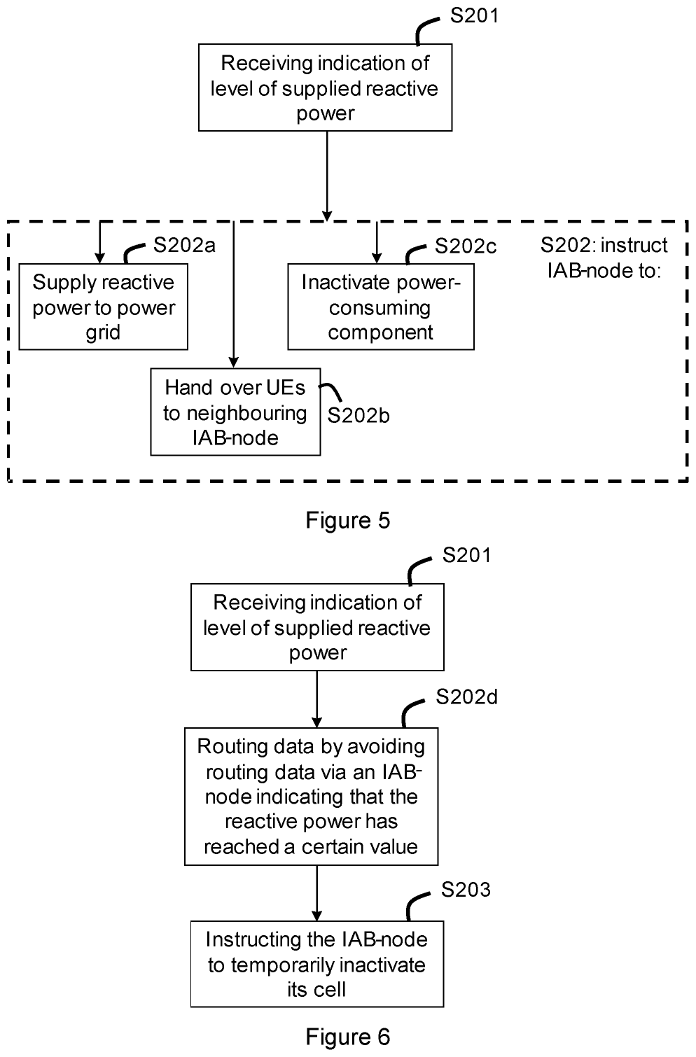

In response thereto, with reference to FIG. 5, the IAB-donor 106 performs an action to stabilize the level of the reactive power of the power grid in step S202, such as instructing one or more of the IAB-nodes 101-105 in step 202a to supply reactive power to the grid (cf. S102a), instructing one or more of the IAB-nodes 101-105 in step S2o2b to hand over UEs to a neighbouring IAB-node (cf. S102b), or instructing one or more of the IAB-nodes 101-105 in step S2o2c to temporarily inactivate one or more of its power-consuming components (cf. S102c).

It may be envisaged that the IAB-donor 106 shares the indications of the IAB-nodes 101-105 with the other IAB-donors 107, 108 and/or a supervisory control and data acquisition (SCADA) system for supervision purposes. The method may be implemented using 5G radio as a service (RAAS) to power grid operators via mobile network operators (MNOs).

In 5G, a Distributed Unit (DU) of the respective IAB-node 101-105 may send the indication as F1 traffic to a Central Unit of the IAB-donor 106. Either a dedicated or a shared backhaul radio link control (RLC) channel on the backhaul links between IAB-node and IAB-donor can be employed to transport the indication of the reactive power level. Another approach could be to send the indication to the IAB-donor 106 via an OAM interface (“Operations, Administration and Maintenance”).

The indication of the IAB-nodes 101-105 may be sent to the IAB-donor 106 using a predetermined control symbol of a communication protocol being used.

With reference to FIG. 6, in a further embodiment, upon receiving from one or more of the IAB-nodes 101-105 in step S201 an indication for instance that a voltage V of the power grid falls below a threshold value V_{T}, and that the reactive power of the grids needs stabilizing, the IAB-donor 106 will route data traffic along a path such that local reactive power of the grid at one or more particular IAB-nodes is stabilized as illustrated with step S2o2d.

Assuming for instance that an indication is received from the third IAB-node 103 that the local power grid voltage at the third node falls under the threshold, the IAB-node 106 may re-route data traffic such that the reactive power of the grid at the third IAB-node 103 is stabilized.

For instance, instead of routing traffic along path IAB1-IAB3-IAB5. The IAB-donor 106 may determine to route (at least temporarily) the traffic along the path IAB1-IAB2-IAB5, thereby avoiding routing of traffic via the third IAB-node 103 such that the reactive power of the grid at the third IAB-node 103 is stabilized.

In a further embodiment, a cell served by the third IAB-node 103 is temporarily inactivated in step S2o3. The IAB-donor 106 may inform the third IAB-node 103 to temporarily inactivate its cell by including the instruction in a master information block (MIB) and an information element (IE) of a system information block (SIB), e.g. SIB1, over an F1 interface. Further, parent IAB-nodes to the third IAB-node 103—i.e. the first IAB-node 101 and the second IAB-node 102—will be informed that the cell of the third IAB-node 103 is temporarily inactivated such that the first IAB-node 101 and the second IAB-node 102 avoid routing data traffic via the third IAB-node 103. Any UE wishing to connect to the third IAB-node 103 could instead connect to the first IAB-node 101 or the second IAB-node 102

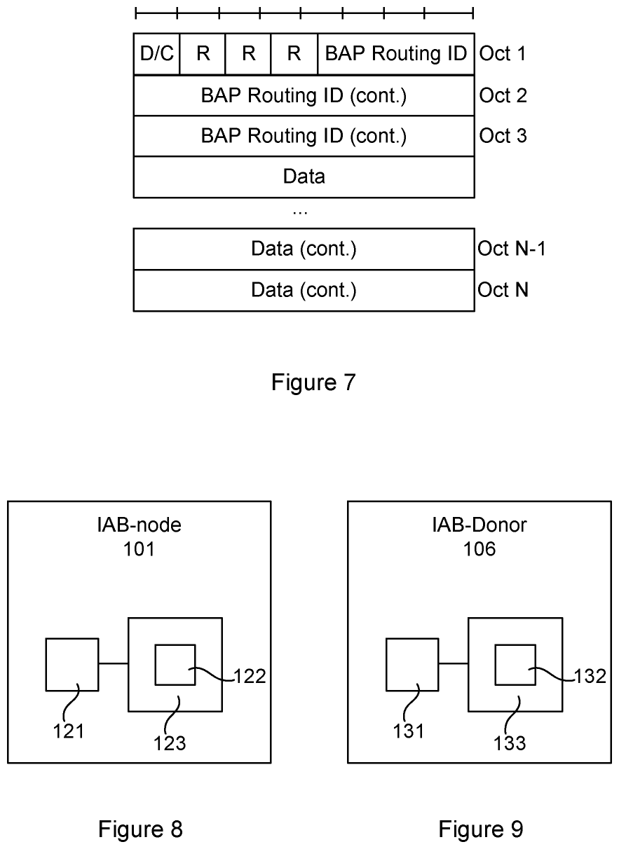

In the IAB network 100, routing of information (carried in F1 and RRC messages) to/from the IAB-donor 106 from/to the IAB-nodes 101-105 may be performed via a Backhaul Adaptation Protocol (BAP) by adding a BAP header to data being communicated as shown in FIG. 7. A BAP packet data unit (PDU) is either a data PDU or a control PDU. A data PDU is used to transport data along a path towards a destination. Therefore, the header of a data PDU has the following components:
D/C bit to indicate if the PDU is BAP control PDU (value 0) or a BAP data PDU (value 1),
3 Reserved bits denoted “R”,
10 bits destination BAP address,
10 bits path id (i.e. which specific path to use to route data to a destination), and data to be transported.

In line with the previous example, where the routing is performed via IAB1-IAB2-IAB5, the BAP header will indicate that the fifth IAB 105 is the destination node and that routing path is over the first IAB-node 101 and the second IAB-node 102, thus avoiding the previous data path over the third IAB-node 103: IAB1-IAB3-IAB5, since the reactive power of the grid should be stabilized at the third IAB-node 103.

As previously mentioned, the indications of the IAB-nodes 101-105 may be sent to the IAB-donor 106 using a predetermined control symbol of a BAP header.

In yet a further embodiment, the respective IAB-node 101-105 and/or the IAB-donor 106 may apply machine learning (ML) to determine which action to perform for stabilizing the reactive power of the grid.

This may be performed by analysing historical data and/or previous decisions having been made. For instance, it may be envisaged that if the measured voltage at the first IAB-node 101 falls under a first voltage threshold value V_{T1}, the first IAB-node 101 concludes from previous decisions that the action of generating a reactive power and supplying the generated reactive power to the power grid is preferred, while if the measured voltage falls under a second voltage threshold value V_{T2}. UEs are to be handed over to a neighbouring IAB-node in order to attain the best result.

Further, the IAB-nodes 101-106 may use ML to determine at which level of the electrical property being measured (voltage, current, reactive power, etc.), stabilization is required. Hence, by training the IAB-nodes 101-106 with data, the nodes may learn at which level of the measured electrical property an action is to be taken.

Alternatively, upon the IAB-nodes 101-105 sending indications that stabilization of reactive power is required, the IAB-donor 106 makes a decision based on ML—from historical data and/or previous actions performed on which action to take, e.g. rerouting data traffic or instructing one or more IAB-nodes 101-105 to perform a certain action as discussed hereinabove such as handing over UEs to a neighbouring IAB-node. Potential ML methods to use include for instance reinforcement learning (RL). In RL, it is common to associate a cost with each action, and the action (or set of actions) resulting in the lowest cost is the action which ultimately will be performed.

As can be concluded, embodiments described herein have many advantages.

Firstly, an RBS/IAB node 101-105 locally determines that power grid stabilization is required, regardless of whether or not the information is sent to a supervising device such as the IAB-donor 106 or if an action is taken locally by the IAB-node. If the information is communicated to the IAB-donor 106, the IAB-donor may communicate the invention to further IAB-donors 107, 108 or core network functions.

Secondly, the information from the IAB-nodes 101-105 that power grid stabilization is required may be included as predetermined control data in a BAP header transmitted to the IAB-donors 106, and possible to IAB-donors 107, 108 and/or a SCADA system for supervision purposes.

Thirdly, a low latency control mechanism for reactive power control is provided as an RBS/IAB node 101-105 locally may take action to stabilize the grid. Even in a scenario where information is communicated to the IAB-donor 106 which suggests an action to be taken, data transmission in the IAB network 100 is fast with the nodes located physically close to each other.

Fourthly, ML such as for instance reinforcement learning may be used to analyse measurement data and take one or more appropriate actions.

FIG. 8 illustrates a radio base station 101 in the form of an IAB-node configured to control reactive power of a power grid. The steps of the method performed by the IAB-node 101 are in practice performed by a processing unit 121 embodied in the form of one or more microprocessors arranged to execute a computer program 122 downloaded to a suitable storage volatile medium 123 associated with the microprocessor, such as a Random Access Memory (RAM), or a non-volatile storage medium such as a Flash memory or a hard disk drive. The processing unit 121 is arranged to cause the IAB-node 101 to carry out the method according to embodiments when the appropriate computer program 122 comprising computer-executable instructions is downloaded to the storage medium 123 and executed by the processing unit 121. The storage medium 123 may also be a computer program product comprising the computer program 122. Alternatively, the computer program 122 may be transferred to the storage medium 123 by means of a suitable computer program product, such as a Digital Versatile Disc (DVD) or a memory stick. As a further alternative, the computer program 122 may be downloaded to the storage medium 123 over a network. The processing unit 121 may alternatively be embodied in the form of a digital signal processor (DSP), an application specific integrated circuit (ASIC), a field-programmable gate array (FPGA), a complex programmable logic device (CPLD), etc.

FIG. 9 illustrates a device 106 in the form of an IAB-donor configured to control reactive power of a power grid. The steps of the method performed by the IAB-donor 106 are in practice performed by a processing unit 131 embodied in the form of one or more microprocessors arranged to execute a computer program 132 downloaded to a suitable storage volatile medium 133 associated with the microprocessor, such as a RAM, or a non-volatile storage medium such as a Flash memory or a hard disk drive. The processing unit 131 is arranged to cause the IAB-donor 106 to carry out the method according to embodiments when the appropriate computer program 132 comprising computer-executable instructions is downloaded to the storage medium 133 and executed by the processing unit 131. The storage medium 133 may also be a computer program product comprising the computer program 132. Alternatively, the computer program 132 may be transferred to the storage medium 133 by means of a suitable computer program product, such as a DVD or a memory stick. As a further alternative, the computer program 132 may be downloaded to the storage medium 133 over a network. The processing unit 131 may alternatively be embodied in the form of a DSP, an ASIC, an FPGA, a CPLD, etc

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-40. (canceled)

41. A method for a radio base station to control reactive power of a power grid, comprising:
measuring an electrical property indicating a level of the reactive power supplied by the power grid to which the radio base station is connected; and
performing an action to stabilize the level of the reactive power of the power grid when the measured electrical property reaches a certain value.

42. The method of claim 41, wherein performing an action to stabilize variation of the reactive power of the power grid comprises generating a reactive power and supplying the generated reactive power to the power grid.

43. The method of claim 41, wherein performing an action to stabilize variation of the reactive power of the power grid comprises one or more of the following:
handing over one or more wireless communication devices served by the radio base station to one or more neighbouring base stations to decrease the load of the radio base station on the power grid;
inactivating power-consuming components of the radio base station to decrease load of the radio base station on the power grid; and
sending, to a supervising device, an indication that the measurement performed by the radio base station indicates that the reactive power of the grid at the radio base station needs to be stabilized.

44. The method of claim 41, wherein the measured electrical property indicating a level of the reactive power supplied by the power grid to which the radio base station is connected is one of the following: voltage, current, or reactive power.

45. The method of claim 41, wherein the action is performed in response to one of the following:
when a measured value of the electrical property falls below a predetermined voltage threshold value, or
when measured values of the electrical property over time vary more than a threshold value from a nominal value.

46. The method of claim 41, further comprising determining one or more of the following using machine learning (ML): the action performed, and the certain value.

47. A method for controlling reactive power of a power grid, the method performed by a device configured to communicate with a group of radio base stations and comprising:
receiving, from at least one of the radio base stations, an indication of a level of reactive power of the power grid to which the at least one radio base station is connected; and
performing an action to stabilize the level of the reactive power of the power grid when the received indication indicates that the level of the reactive power of the power grid has reached a certain value.

48. The method of claim 47, wherein performing an action to stabilize the level of the reactive power of the power grid comprises instructing the at least one radio base station to perform one or more of the following:
generate a reactive power and to supply the generated reactive power to the power grid; and
hand over one or more wireless communication devices served by the at least one radio base station to one or more neighbouring base stations to decrease the load of the at least one radio base station on the power grid.

49. The method of claim 47, wherein performing an action to stabilize the level of the reactive power of the power grid comprises instructing the at least one radio base station to perform one or more of the following:
inactivate power-consuming components of the at least one radio base station to decrease the load of the at least one radio base station on the power grid; and
route data to the group of radio base stations, such that no data is routed via a radio base station from which a received indication indicates that the level of the reactive power of the power grid has reached the certain value.

50. The method of claim 49, wherein performing an action to stabilize the level of the reactive power of the power grid further comprises instructing a radio base station, from which a received indication indicates that the level of the reactive power of the power grid has reached a certain value, to inactivate a radio cell it is serving.

51. The method of claim 47, wherein the received indication of the level of reactive power of the power grid to which said at least one radio base station is connected is included in a predetermined controlled symbol in a Backhaul Adaptation Protocol (BAP) header.

52. The method of claim 47, determining one or more of the following using machine learning (ML): the action performed, and the certain value.

53. A radio base station configured to control reactive power of a power grid, the radio base station comprising:
one or more processors; and
a storage medium containing computer-executable instructions, wherein execution of the instructions by the one or more processors causes the radio base station to:
measure an electrical property indicating a level of the reactive power supplied by the power grid to which the radio base station is connected; and
perform an action to stabilize the level of the reactive power of the power grid when the measured electrical property reaches a certain value.

54. The radio base station of claim 53, wherein execution of the instructions by the one or more processors causes the radio base station to perform an action to stabilize variation of the reactive power of the power grid based on generating a reactive power and supplying the generated reactive power to the power grid.

55. The radio base station of claim 53, wherein execution of the instructions by the one or more processors causes the radio base station to perform an action to stabilize variation of the reactive power of the power grid based on one or more of the following:
hand over one or more wireless communication devices served by the radio base station to one or more neighbouring base stations to decrease the load of the radio base station on the power grid;
inactivate power-consuming components of the radio base station to decrease load of the radio base station on the power grid; and
send, to a supervising device, an indication that the measurement performed by the radio base station indicates that the reactive power of the grid at the radio base station needs to be stabilized.

56. The radio base station of claim 53, wherein execution of the instructions by the one or more processors causes the radio base station to perform the action in response to one of the following:
when a measured value of the electrical property falls below a predetermined voltage threshold value, or
when measured values of the electrical property over time vary more than a threshold value from a nominal value.

57. A device configured to communicate with a group of radio base stations for controlling reactive power of a power grid, the device comprising:
one or more processors; and
a storage medium containing computer-executable instructions, wherein execution of the instructions by the one or more processors causes the device to:
receive, from at least one of the radio base stations, an indication of a level of reactive power of the power grid to which the at least one radio base station is connected; and
perform an action to stabilize the level of the reactive power of the power grid when the received indication indicates that the level of the reactive power of the power grid has reached a certain value.

58. The device of claim 57, wherein execution of the instructions by the one or more processors causes the device to perform an action to stabilize the level of the reactive power of the power grid based on instructing the at least one radio base station to perform one or more of the following:
generate a reactive power and to supply the generated reactive power to the power grid; and
hand over one or more wireless communication devices served by the at least one radio base station to one or more neighbouring base stations to decrease the load of the at least one radio base station on the power grid.

59. The device of claim 57, wherein execution of the instructions by the one or more processors causes the device to perform an action to stabilize the level of the reactive power of the power grid based on instructing the at least one radio base station to perform one or more of the following:
inactivate power-consuming components of the at least one radio base station to decrease the load of the at least one radio base station on the power grid; and
route data to the group of radio base stations, such that no data is routed via a radio base station from which a received indication indicates that the level of the reactive power of the power grid has reached the certain value.

60. The device of claim 57, wherein execution of the instructions by the one or more processors causes the device to perform an action to stabilize the level of the reactive power of the power grid based on instructing a radio base station, from which a received indication indicates that the level of the reactive power of the power grid has reached the certain value, to inactivate a radio cell it is serving.
